(19) United States
(12) Patent Application Publication
(10) Pub. No.: US 2017/0104698 A1
(43) Pub. Date: Apr. 13, 2017

(54) Instant Messaging

(71) Applicant: Microsoft Technology Licensing, LLC, Redmond, WA (US)

(72) Inventor: Cezary Benedykt Tomczyk, U Jezera (CZ)

(21) Appl. No.: 14/946,459

(22) Filed: Nov. 19, 2015

(30) Foreign Application Priority Data
Oct. 7, 2015 (GB) 1517739.7

(51) Int. Cl. H04L 12/58

(52) U.S. Cl. CPC H04L 51/04; H04L 51/24

(57) ABSTRACT

A method comprising: (a) receiving an indication that, having completed composing a message in an instant messaging client application, a sending user has actuated a user interface control for triggering the instant messaging client application to send the message to a recipient user via an instant messaging service; (b) automatically detecting that the recipient user is not currently available via the instant messaging service; (c) in response to said detection, automatically controlling a user interface of the sending user terminal to output a prompt to the sending user asking for confirmation to send the message via email in lieu of the instant messaging service; and (d) in response to said confirmation, sending the message in an email to an email address of the recipient user.

### RELATED APPLICATION

This application claims priority under 35 USC 119 or 365 to Great Britain patent application number 1517739.7, titled “Instant Messaging” and filed on Oct. 7, 2015, the entire disclosure of which is incorporated by reference herein.

### BACKGROUND

Various different technologies for communicating over the Internet have been developed over the years.

One such technology is known as instant messaging (IM), or sometimes “IM chat”. According to the principles of IM, each user of the messaging service installs and runs on his or her user terminal a proprietary communication client application provided by an operator of the instant messaging service, and IM messages are sent from the client to another instance of the client on the recipient's user terminal to the by push notification, but the messages can only be exchanged between users who have mutually agreed to become contacts of one another. To facilitate this, a server of the instant messaging service maintains a contact list for each of its users, listing which other users of the service that respective user has agreed to accept as a contact (which also requires the other contact to have accepted the first user as a contact). When a user logs in to the IM service via his or her IM client, the client accesses the contact list from the IM server and makes these contacts visible to the sending user through the front-end of the IM client application. Based on this, the sending user can then select one of the contacts in order to establish a connection with that contact as a recipient of an IM message. The sending user inputs a textual message through the front-end user interface of the sending client, and initiates sending. The message is then sent to the IM server, where if the recipient is online and logged in to the service, the server forwards the message on to the recipient user's terminal by push notification. If the recipient is not logged in to the service, the IM server stores the message until the recipient is next logged in and delivers the message by push notification then.

Another form of Internet communication is email. While IM messages can only be exchanged between users who have mutually accepted one another as contacts, email is unguarded in that an email can be sent to any recipient as long as the recipient's email address is known. Also unlike IM services, email is not a proprietary system. While a given IM service can only be accessed via the proprietary client application of one specific provider of that service, instead for email many different parties can provide different interoperable email clients. Nor do emails have to be sent via the server operated by any one specific provider. When the sending user sends an email from the email client on his or her email client, the email is sent initially to a mail server of the sender's domain, which looks up the recipient user's email address in a third-party domain name server (DNS), and based on this forwards the email to the recipient's terminal via a mail server of the recipient's domain. Furthermore, unlike IM, email is typically not sent by push notification. Typically the email client on the recipient's terminal has to poll its respective mail server to check whether any emails are waiting to be delivered to the recipient.

Instant messaging is often preferred as a means of communication, particularly for more fast-paced or time-critical conversations between friends, family or colleagues; while email tends to be used for more formal or long-winded messages.

### SUMMARY

However, even if a sender and recipient are both users of a given IM service and have both previously accepted one another as contacts, nonetheless, at any given time the recipient may happen not to be available through an IM service, e.g. because the recipient user is not logged in to the IM client of that service, or has set his or her presence status within the IM service to “do not disturb”.

According to one aspect disclosed herein, there is provided a method comprising: (a) receiving an indication that, having completed composing a message through an instance messaging client application, a sending user has actuated a user interface control for triggering an instant messaging client application to send a message to a recipient user via an instant messaging service, the recipient user also being a user of the instant messaging service, having a recipient user terminal installed with a respective instance of the instant messaging client application for receiving messages via the instant messaging service; (b) automatically detecting that the recipient user is not currently available via the instant messaging service; (c) in response to said indication, and on condition of said detection, automatically controlling a user interface of the sending user terminal to output a prompt to the sending user asking for confirmation to send the (completed) message via email in lieu of the instant messaging service; and (d) in response to said confirmation, sending the message in an email to an email address of the recipient user.

In embodiments, the method may be implemented at a server, the server receiving said indication from the instant messaging client application running on the sending user terminal. Alternatively the method may be implemented by the communication client application running on the sending user terminal.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter. Nor is the claimed subject matter limited to implementations that solve any or all of the disadvantages noted in the Background section.

### BRIEF DESCRIPTION OF THE DRAWINGS

To assist understanding of the present disclosure and to show how embodiments may be put into effect, reference is made by way of example to the accompanying drawings in which:

FIG. 1 is a schematic block diagram of a communication system, and

FIG. 2 is a schematic illustration of a user interface.

### DETAILED DESCRIPTION

The following discloses a system and method addressing the issue that a sending user may wish to send IM messages to some of his or her contacts even when those contacts are offline or not using the IM service frequently. This is achieved by sending the message from the sender's IM client to an email address of the recipient (if defined) such that the message will be delivered to the recipient via email. Thus the sending user is able to continue communicating using instant messaging (in the sense that the messages are entered through the IM client, intended by the sending user as IM messages, and forming part of a thread or chain of messages in an IM conversation), and in embodiments the history of the conversation is maintained through the recipient's e-mail inbox.

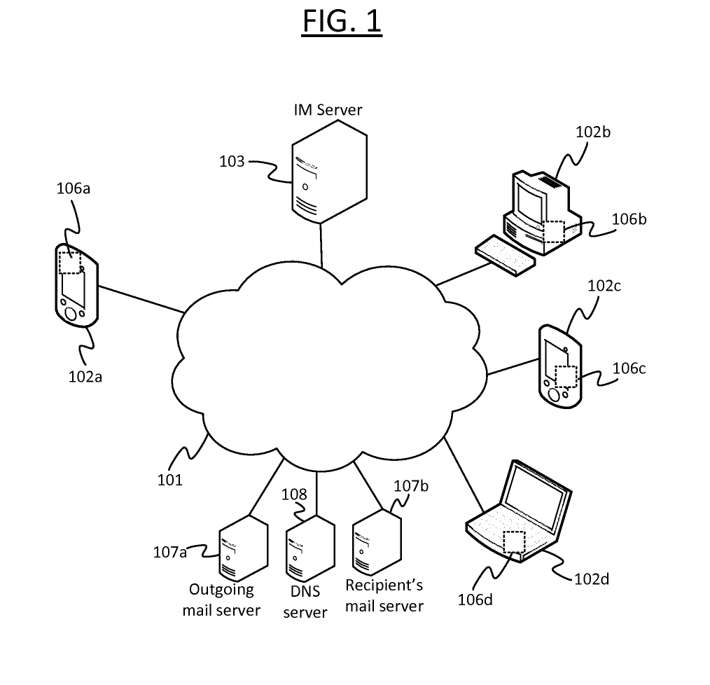

FIG. 1 shows an example of a communication system in accordance with embodiments of the present disclosure. The system comprises a network 101 in the form of the Internet (a wide area internetwork). The system also comprises a plurality of user terminals 102a-d each connected to the Internet 101 by a respective wired or wireless connection. The system further comprises an IM server 103, multiple mail servers 107 and a domain name server (DNS) 108 each also connected to the Internet 101.

Each of the user terminals 102 may take any suitable form such as a smartphone, tablet, laptop or desktop computer (and the different user terminals 102 need not necessarily be the same kind). Whatever form they take, each of the user terminals 102 may be connected to the Internet by means of any suitable wired or wireless interface, e.g. a wired modem, or a mobile cellular modem, or a local wireless interface using a local wireless access technology such as a Wi-Fi network to connect to a wireless router in the home or office (which connects onwards to the Internet 101).

Each of at least some of the user terminals 102a-d is installed with a respective instance of a communication client application 106a-d. The communication client application 106 comprises an IM chat client by which the respective users of two or more of the user terminals 102 can exchange textual message over the Internet 101. Optionally the client application 106 may also comprise other, additional functionality such as the ability to send pre-recorded video messages or establish live voice or video calls between the user terminals 102.

In embodiments, the IM messages referred to herein may be sent between user terminals 102 via a server 103, operated by a provider of the IM service, typically also being a provider of the communication client application. Alternatively however, the IM messages may be sent directly over the Internet 101 without travelling via any server, based on peer-to-peer (P2P) techniques. The following may be described in terms of a server based implementation of the IM service, but it will be appreciated this is not necessarily limiting to all embodiments. Note also that where a server referred to anywhere herein, this refers to a logical entity being implemented on one or more physical server units at one or more geographical sites.

For purpose of illustration the following will be described in terms of a first user terminal 102a being a sending (near-end) user terminal, sending a message to another, receiving (far-end) one of the user terminals 102b. However, it will be appreciated that in embodiments the teachings herein can also apply between any combination of the user terminals 102a-d, etc., and their respective users, as sender and receiver.

The IM server 103 stores a database of all the users who have registered as users of the IM service. The database comprises a respective username for each of these users, and mapped to each of the usernames: a respective IP address of the respective user's terminal 102, a respective profile of the respective user, a respective contact list for each of the users, and a respective presence status of the respective user. The mapping of usernames to IP addresses enables the username to be resolved to a corresponding destination terminal 102 on the Internet 101. The contact list records which with users of the IM service the respective user has accepted as a contact (and who have also accepted the respective user as a contact).

The presence status comprises an indication as to the respective user's availability to be communicated with via the IM service. For instance the presence status may indicate whether the respective user is online and logged in to the IM service, or logged out of the IM service, and in embodiments the presence status may also distinguish between different availability states in which the respective user is logged: e.g. whether the respective user has selected to appear as unavailable (“do not disturb”), and/or whether the respective user has interacted with his or her respective user terminal 102 within a predetermined time window (if not it may be inferred that the user is not using that terminal and therefore not available).

The profile is the user's profile within the IM service, by which the respective user is represented within the IM service. That is, it comprises information on the respective user that is arranged to be used in relation to that user's use of the IM service. This profile information may comprise information which will be displayed to other users of the IM service when selecting the respective user as a potential contact or as a recipient through their own instances of the IM client application 106, and/or the profile information may comprise one or more settings personalizing the way the IM service operates in relation to the respective user whose profile it is. In embodiments, some limited amount of the profile information (such as a display name and/or thumbnail profile picture) may be visible to other users of the IM service who are not yet contacts search for potential contacts, whilst some further parts of the profile information (e.g. home town, phone number and/or full profile image) may be visible to other users of the IM service only once accepted as contacts. Some further part of the profile information may only be visible to the operator of the IM service and not any of the users. E.g. the latter kind may comprise one or more settings personalizing the behaviour of the IM service to the respective user.

In operation, one of the sending and receiving users selects through his or her client application 106a to send a contact request to the other (for example after having found the potential contact through a search function provided to the sending client 106a by the IM server 103). In response, the sending client application 106a sends the contact request from the sending user terminal 102a to the client application 106b on the receiving user terminal 106b. If the other user selects though his or her respective client 106b to accept the contact request, each of the two users are added to the contact list of the other as stored in the IM server 103.

Once accepted as contacts, the sending user can send an IM message to the contact as a recipient. To do this, the sending user composes messages via a front-end user interface of the sending client application 106a presented through a user interface apparatus of the sending user terminal 102a (e.g. a touch screen, or screen with keyboard and/or mouse). In association with the body of the message, the sending user also uses the user interface to select a recipient of the message, e.g. selecting the recipient user from the contact list, or by manually typing in the recipient's username. Based on this, the sending client 106a transmits the message over the Internet 101 to the receiving client 106b on the recipient user's user terminal 102b, by using the server 103 to look up the IP address of the recipient user terminal 102b as mapped to the recipient's username. In embodiments, the messages are actually sent via the server 103, i.e. the server 103 receives the message from the sending user terminal 102a and forwards it on to the recipient user terminal 102b via push notification (or alternatively in P2P implementations, the sending client 106a sends the message by push notification directly from the sending user terminal 102a to the receiving user terminal 102b, using the IM server 103 to look of the recipient IP address).

In embodiments, the IM client 106 also facilitates messages to be organized into chains (or “threads”) of conversation. In this case, when the sending user has sent or received a previous message to or from the recipient via the IM server 103, the sending user has the option to select to send a second message to the recipient by selecting the previous message, and the clients 106a, 106b present the two messages to the respective users as part of the same conversation (i.e. the same logical thread). Further, when two or more messages have been exchanged as part of the same conversation, the sending user has the option to select to send a further message to the recipient by selecting the conversation through the user interface of the sending client application 103a. Thus when the sending user exchanges multiple messages with the recipient user via the IM service, the client 106 on each of the sending and receiving terminals 102a, 102b presents the messages as a conversation with a history, i.e. a chain of messages arranged in an order in which they were sent or received. Note that in embodiments the conversation may comprise a mixture of textual IM messages and messages comprising one or more other types of media, e.g. video messages. Also, the conversation may comprise more than two users (so the described recipient is not necessarily the only recipient, but for purpose of discussion the present disclosure is described in terms of a sender and a particular one or the one or more recipients).

Thus based on the techniques summarized above, a sending user can use an IM service to send a message to a recipient user. Typically, IM tends to be used for casual and/or fast-paced exchanged of short messages, where the sending user may expect relatively attention to the message.

However, as mentioned, there is a potential issue in that at any given time the recipient user may not in fact be available through the IM service. For instance, this could be because the recipient is not logged in to the IM service, or has set his or her presence status to do-not-disturb (DND). Or perhaps although logged in and not having DND set, the recipient's client 106b may be able to detect that the recipient user has not, within a certain time window (e.g. 15 mins), interacted with (not performed any user input to) the respective user terminal 102b on which the receiving client 106b is installed. This is another form of presence information indicating an availability of the recipient.

To address such situations, or similar, according to embodiments of the present disclosure the sender's client application 106a or the IM server 103 is configured to read the recipient user's presence status in order to detect whether the recipient is currently available to receive IM messages via the IM service, and to automatically send an attempted IM message to the recipient via email instead. That is, when the sending user composes a message through the user interface of his or her IM client 106a, and selects through his or her IM client 106a to send an IM message to the recipient via the IM, but the recipient is not currently available via the IM service, one of two things happens: either (i) the sending client sends the IM message to the IM server 103 as normal, but the IM server detects from the presence status that the recipient is not available and automatically sends the message to the recipient's terminal 102b by email, or (ii) the sending client 106a detects from the presence status maintained by the IM server 103 that the recipient user is unavailable, and automatically sends the message to the recipient's terminal 102b via email. The following will be described by way of illustration in terms of the latter, server-based variant, but it will be appreciated that the same principles may be applied to the former, client-based variant (with the relevant actions of the IM server 103 described below instead being performed by the sending client 106a).

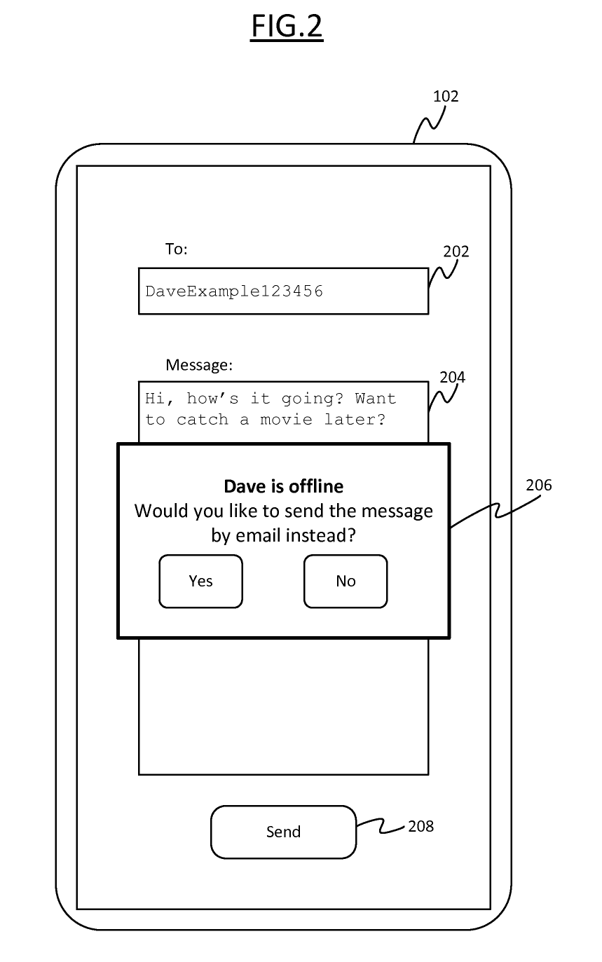

Referring to FIG. 2, the sending client 106a, through its user interface, presents the sending user with a field 204 through which the sending user can compose a textual message. The sending client 106a also presents the sending user with a control 202 enabling the sending user to select a recipient, e.g. by typing the username of the recipient, or selecting the recipient from the sending user's contact list, or by selecting an existing conversation. Further, the sending client 106a presents the sending user with a user interface control 208 by which, once he or she has finished composing the message, he or she can select to send the message. For example this may comprise a button which the user can click with a mouse cursor or touch though a touch screen in order to trigger the sending of the message. When the sending user does so, the sending client 106a sends the message from the user terminal 102 as an IM message to the IM server 103. In response, the IM server 103 checks from the presence status of the recipient whether the recipient is currently available to be messaged via the IM service. If not, it automatically sends the body (user content) of the message in an email to the recipient.

In embodiments, the IM server 103 reports to the sending client 106a that the recipient is not available for communication via the IM service, and in response the sending client 106a presents the sending user (via its user interface) with a message 206 informing the sending that the message will or may be sent by email. In embodiments, the message 206 comprises a prompt asking the sending user to confirm whether he or she wishes the message to be sent by email. When the user confirms one way or the other, a signal giving the sending user's response is sent from the sending client 106a on the sending terminal 102a to the IM server, and the IM server 103 acts accordingly.

To send the email, the server 103 first determines an email address of the recipient user. It may determine the email address either by receiving an email address of the recipient specified by the sender (e.g. via the prompt 206), or by looking up an email address of the recipient in the recipient user's profile (the recipient's profile within the IM service). The IM server then sends the email to an outgoing mail server 107a associated with the IM service. In response, the outgoing mail server 107a consults a domain name server (DNS) 108 to resolve the domain name of the recipient's email address, and based on this, the outgoing mail server 107a sends the email to a mail server 107b of the recipient. Alternatively the IM server 103 may be configured to consult the DNS server 108 directly to resolve the domain of the recipient, and thereby send the email from the server 103 to the recipient's mail server 107b. Either way, the recipient's mail server 107b then delivers the email to an email client (not shown) running on the recipient's user terminal 102b. Typically this requires the recipient's email client to poll the recipient's mail server 107b.

Note: in embodiments, the server 103 may also continue to attempt to deliver the message via IM as well as email (so the recipient also gets the message by IM next time available through the IM service, e.g. next time he or she logs in to the IM service). Alternatively the server 103 may not attempt to send the message by IM when sent by email.

In a client-based implementation, the outgoing mail server 107a represents a mail server associated with the sending user. In this case the sending client 106a sends the email to the sending user's mail server 107a, and then the process continues in a similar manner to the above: i.e. in response to receiving the email, the sending user's mail server 107a consults the DNS server 108 to resolve the domain name of the recipient's email address, and based on this, sends the email to a mail server 107b of the recipient. Again, the sending client 106a may also send the message by IM in parallel (to be stored at the IM server 103 until the recipient is next available by IM), or alternatively the sending client 106a may send the message only by email if the recipient is not available by IM.

Some further exemplary features are now discussed in more detail. The following features may be performed by the IM server 102 or sending client 106a as appropriate, and in dependence on whether the email forwarding is server-based or client-based.

In embodiments, (as mentioned) the email address may be automatically retrieved from a profile of recipient user stored by the instant messaging service, wherein sending of the email is to the email address as retrieved from the profile of the recipient user.

In particular embodiments of this, the profile may further comprises a setting having a settable value by which the recipient user can opt in or out of receiving instant messaging messages via email, or opt in or out of making the email address available to other users of the messaging service. In this case, the value of said setting may be automatically read from the profile of the recipient user, and said sending may be performed on condition that the recipient user has opted in via the setting in said profile.

As another possibility, the user interface of the sending user terminal may be controlled to present the sending user with an option to manually enter the email address of the receiving user. In this case the sending of the email may be to the email address as entered manually by the sending user through said option. E.g. the option to manually enter the email address may be presented as part of the prompt, in response to said detection that the recipient user is not available via the instant messaging service.

In embodiments, the method may comprise attempting to retrieve the email address from a profile of recipient user stored by the instant messaging service, and: if the email address is available in the recipient's profile, the sending of the email is to the email address as retrieved from the profile of the recipient user; but if the email address is not available in the recipient's profile, the method further comprises presenting the sending user with an option to manually enter the email address of the recipient user, wherein the sending of the email is to the email address as entered by the sending user through said option. E.g. again this option may be presented as part of the prompt, in response to said detection that the recipient user is not available via the instant messaging service.

Thus if the recipient user has in his or her profile an email which he or she opted in to be used by the IM service, the message will be sent to that email address without any additional steps needing to be performed by the sending user. But if the recipient user has not made his or her email address available in his or her profile, the sending client 106a may present the sending user with a dialogue such as “Please enter a destination email address”, and the message will then be sent to that address.

Where the email address is not available in the recipient's profile, this could be because no email address of the recipient is present in the recipient's profile (the recipient user has not included one at all) or because the email address is not allowed to be accessed by contacts, or at least not for this purpose (i.e. the recipient user has included an email address in his or her profile but has not opted in).

For example, the recipient may have included an email address in his or her profile so he or she can be contacted by the operator of the IM service if need be, but may have selected a setting in his or her profile specifying that the email address is not to be visible to other users through the IM service. In a client-based implementation of the email forwarding feature, the sending client 106a would therefore not have access to the recipient's email address, and therefore would have to prompt the sending user for a destination email address. However, in a server-based implementation, in embodiments the IM server 103 could still use the email address from the recipient's profile to forward the message by email without making this email address visible to the sending user.

As another example, the recipient may have included an email address in his or her profile and this may even be visible for contacts of the recipient (including the sender) to view in the profile through the IM service. However, the service may provide a setting in the profile by which the recipient user can opt not to have IM message forwarded by email. In this case the server 103 or sending client 106a is configured to respect this setting accordingly.

The email itself comprises the content of the message being sent (i.e. the text composed by the sending user), and also an indication of the sender of the message (e.g. the sender's username within the IM service, and/or the sending user's display name, typically the sender's real name).

In further embodiments, the email contains one or more further elements inserted by the IM server 103 or sending client 106a (depending on implementation).

For instance, the email may contain a human-readable explanation explaining to the recipient that the message was sent by the instant client of the sending user, and/or that the message was originally intended as an instant messaging message to be sent through the instant messaging service. Alternatively or additionally, the email may human-readable title or topic of an instant messaging conversation of which the message forms a part. Thus the recipient can understand the context of the message being received by email.

Alternatively or additionally, the email may contain a user-actionable link which the recipient user can select to link to an instant messaging conversation of which the message forms a part. For example, a “call to action” (CTA) button or other such control may be included in the email, which upon clicking or touching the recipient user is redirected to a web client version of the IM client 106 to view the message in context of the conversation of which that message forms a part (displayed with the messages positioned in the order in which they were sent, with the message that was notified by email being displayed in the appropriate place in the order relative to the other messages).

It will be appreciated that the above embodiments have been described only by way of example.

Generally, any of the functions described herein can be implemented using software, firmware, hardware (e.g., fixed logic circuitry), or a combination of these implementations. The terms “module,” “functionality,” “component” and “logic” as used herein generally represent software, firmware, hardware, or a combination thereof. In the case of a software implementation, the module, functionality, or logic represents program code that performs specified tasks when executed on a processor (e.g. CPU or CPUs). The program code can be stored in one or more computer readable memory devices. The features of the techniques described below are platform-independent, meaning that the techniques may be implemented on a variety of commercial computing platforms having a variety of processors.

For example, the user terminals and/or server may also include an entity (e.g. software) that causes hardware of the user terminals to perform operations, e.g., processors functional blocks, and so on. For example, the user terminals and/or server may include a computer-readable medium that may be configured to maintain instructions that cause the user terminals, and more particularly the operating system and associated hardware of the user terminals to perform operations. Thus, the instructions function to configure the operating system and associated hardware to perform the operations and in this way result in transformation of the operating system and associated hardware to perform functions. The instructions may be provided by the computer-readable medium to the user terminals and/or server through a variety of different configurations.

One such configuration of a computer-readable medium is signal bearing medium and thus is configured to transmit the instructions (e.g. as a carrier wave) to the computing device, such as via a network. The computer-readable medium may also be configured as a computer-readable storage medium and thus is not a signal bearing medium. Examples of a computer-readable storage medium include a random-access memory (RAM), read-only memory (ROM), an optical disc, flash memory, hard disk memory, and other memory devices that may us magnetic, optical, and other techniques to store instructions and other data.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

1. A method comprising:
receiving an indication that, having completed composing a message through an instant messaging client application, a sending user has actuated a user interface control for triggering the instant messaging client application to send the message to a recipient user via an instant messaging service, the recipient user also being a user of the instant messaging service, having a recipient user terminal installed with a respective instance of the instant messaging client application for receiving messages via the instant messaging service;
automatically detecting that the recipient user is not currently available via the instant messaging service;
in response to said indication, and on condition of said detection, automatically controlling a user interface of the sending user terminal to output a prompt to the sending user asking for confirmation to send the message via email in lieu of the instant messaging service; and
in response to said confirmation, sending the message in an email to an email address of the recipient user.

2. The method of claim 1, comprising automatically retrieving the email address from a profile of recipient user stored by the instant messaging service, wherein sending of the email is to the email address as retrieved from the profile of the recipient user.

3. The method of claim 2, wherein the profile further comprises a setting having a settable value by which the recipient user can opt in or out of receiving instant messaging messages via email, or opt in or out of making the email address available to other users of the messaging service; and the method comprises automatically reading the value of said setting from the profile of the recipient user, wherein said sending is performed on condition that the recipient user has opted in via the setting in said profile.

4. The method of claim 1, wherein the method comprises automatically controlling the user interface of the sending user terminal to present the sending user with an option to manually enter the email address of the receiving user, and wherein the sending of the email is to the email address as entered manually by the sending user through said option.

5. The method of claim 1, wherein the method comprises attempting to retrieve the email address from a profile of recipient user stored by the instant messaging service, and:
if the email address is available in said profile, the sending of the email is to the email address as retrieved from the profile of the recipient user; or
if the email address is not available in said profile, the method further comprises presenting the sending user with an option to manually enter the email address of the recipient user, and wherein the sending of the email is to the email address as entered by the sending user through said option.

6. The method of claim 5, wherein said option is presented as part of the prompt, in response to said detection that the recipient user is not available via the instant messaging service.

7. The method of claim 1, wherein the email contains a user-actionable link which the recipient user can select to link to an instant messaging conversation of which the message forms a part.

8. The method of claim 1, wherein the email contains a human-readable explanation explaining to the recipient that the message was sent by the instant client of the sending user and/or that the message was originally intended as an instant messaging message to be sent through the instant messaging service.

9. The method of claim 1, wherein the email contains a human-readable title or topic of an instant messaging conversation of which the message forms a part.

10. The method of claim 1, wherein the recipient user not being available comprises the recipient user not being logged in to the instant messaging client, or the recipient user having a do-not-disturb setting turned on in relation to the instant messaging service.

11. The method of claim 1, wherein the method is implemented at a server, the server receiving said indication from the instant messaging client application running on the sending user terminal.

12. The method of claim 1, wherein the method is implemented by the communication client application running on the sending user terminal.

13. A computer program product embodied on a computer-readable storage medium and configured to perform operations comprising:
receiving an indication that, having completed composing a message through an instant messaging client application, a sending user has actuated a user interface control for triggering the instant messaging client application to send the message to a recipient user via an instant messaging service, the recipient user also being a user of the instant messaging service, having a recipient user terminal installed with a respective instance of the instant messaging client application for receiving messages via the instant messaging service;
automatically detecting that the recipient user is not currently available via the instant messaging service;
in response to said indication, and on condition of said detection, automatically controlling a user interface of the sending user terminal to output a prompt to the sending user asking for confirmation to send the message via email in lieu of the instant messaging service; and
in response to said confirmation, sending the message in an email to an email address of the recipient user.

14. A network element configured to perform operations comprising:
receiving an indication that, having completed composing a message through an instant messaging client application, a sending user actuated a user interface control for triggering the instant messaging client application to send the message to a recipient user via an instant messaging service, the recipient user also being a user of the instant messaging service, having a recipient user terminal installed with a respective instance of the instant messaging client application for receiving messages via the instant messaging service;
automatically detecting that the recipient user is not currently available via the instant messaging service;
in response to said indication, and on condition of said detection, automatically controlling a user interface of the sending user terminal to output a prompt to the sending user asking for confirmation to send the message via email in lieu of the instant messaging service; and
in response to said confirmation, sending the message in an email to an email address of the recipient user.

15. The network element of claim 14, further configured to perform an operation of: automatically retrieving the email address from a profile of recipient user stored by the instant messaging service, wherein sending of the email is to the email address as retrieved from the profile of the recipient user.

16. The network element of claim 15, wherein the profile further comprises a setting having a settable value by which the recipient user can opt in or out of receiving instant messaging messages via email, or opt in or out of making the email address available to other users of the messaging service; and the network element is configured to automatically reading the value of said setting from the profile of the recipient user, wherein said sending is performed on condition that the recipient user has opted in via the setting in said profile.

17. The network element of claim 15, wherein the network element is configured to attempting to retrieve the email address from said profile of recipient user stored, and:
if the email address is available in said profile, the sending of the email is to the email address as retrieved from the profile of the recipient user; or
if the email address is not available in said profile, the method further comprises presenting the sending user with an option to manually enter the email address of the recipient user, and wherein the sending of the email is to the email address as entered by the sending user.

18. The network element of claim 14, wherein the network element is configured to include in said email a user-actionable link, which the recipient user can select to link to an instant messaging conversation of which the message forms a part.

19. The network element of claim 14, wherein the network element is a server arranged to receive said indication from the instant messaging client application running on the sending user terminal.

20. The network element of claim 14, wherein the network element is the sending user terminal.
